(19) United States
(12) Patent Application Publication
(10) Pub. No.: US 2023/0337570 A1
(43) Pub. Date: Oct. 26, 2023

(54) ROW UNIT DEPTH ADJUSTMENT SYSTEM AND METHOD

(71) Applicant: CNH Industrial America LLC, New Holland, PA (US)

(72) Inventors: Michael Christopher Conboy, Chicago, IL (US); Trevor Stanhope, Oak Lawn, IL (US)

(21) Appl. No.: 17/726,003

(22) Filed: Apr. 21, 2022

(51) Int. Cl. A01B 79/02; A01B 63/00; A01B 63/16; A01C 5/06

(52) U.S. Cl. CPC A01B 79/02; A01B 63/008; A01B 63/16; A01C 5/064

(57) ABSTRACT

A system for a row unit of a planting implement can include a frame and a disk opener rotatably coupled to the frame. The disk opener can be configured to form a furrow within a field across which the planting implement is traveling. An actuator can be operably coupled with the disk opener and can be configured to alter a position of the disk opener relative to the frame. A depth sensor can be configured to capture data indicative of a detected furrow depth of the furrow. A computing system can be communicatively coupled to the actuator. The computing system can be configured to receive the data indicative of the detected furrow depth of the furrow and activate the actuator to alter the position of the disk opener relative to the frame based on a deviation of the detected furrow depth of the furrow from a defined furrow depth range.

### FIELD

The present disclosure generally relates to planting implements and, more particularly, to a row unit for a planting implement that can include a furrow depth adjustment system.

### BACKGROUND

Planting implements may be employed to deposit an agricultural product, such as a seed, fertilizer, pesticide, and other chemicals and materials, into soil. In some cases, the planting implements can include one or more furrow-forming tools or openers that excavate a furrow or trench in the soil. One or more dispensing devices of the planting implements may, in turn, deposit the agricultural product into the furrow. After deposition of the agricultural product, a closing assembly may close the furrow in the soil, such as by pushing the excavated soil into the furrow.

The desired depth of the furrow can vary depending on various parameters associated with the field and/or the agricultural product. For example, the desired depth of the furrow varies depending on the soil moisture content of the field. In this respect, furrow depth adjustment systems for planting implements have been developed. While such systems work well, an improved furrow depth adjustment system for a planting implement would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to a system for a planting implement having one or more row units. The system includes a frame and a disk opener rotatably coupled to the frame. The disk opener is configured to form a furrow within a field across which the planting implement is traveling. An actuator is operably coupled with the disk opener and configured to alter a position of the disk opener relative to the frame. A depth sensor is configured to capture data indicative of a detected furrow depth of the furrow. A computing system is communicatively coupled to the actuator. The computing system is configured to receive the data indicative of the detected furrow depth of the furrow and activate the actuator to alter the position of the disk opener relative to the frame based on a deviation of the detected furrow depth of the furrow from a defined furrow depth range.

In some aspects, the present subject matter is directed to a method for an agricultural operation. The method includes receiving a first defined furrow depth range for a first row unit. The method also includes receiving, from a first depth sensor, data indicative of a first detected furrow depth of a first furrow. The method further includes comparing, with a computing system, the first defined furrow depth range to the first detected furrow depth of the first furrow. Lastly, the method includes altering, with a first actuator operably coupled with the computing system, a position of a first disk opener of the first row unit when the first detected furrow depth of the first furrow varies from the first defined furrow depth range.

In some aspects, the present subject matter is directed to a system for a planting implement. The system includes a toolbar. A first row unit is coupled to the toolbar. The first row unit includes a first frame; a first disk opener rotatably coupled to the first frame, the first disk opener configured to form a first furrow within a field across which the planting implement is traveling; a first depth sensor configured to capture data indicative of a detected furrow depth of the first furrow, and a first actuator operably coupled with the first disk opener and configured to alter a position of the first disk opener relative to the first frame. A second row unit is coupled to the toolbar. The second row unit includes a second frame; a second disk opener rotatably coupled to the second frame, the second disk opener configured to form a second furrow within a field across which the planting implement is traveling; a second depth sensor configured to capture data indicative of a detected furrow depth of the second furrow, and a second actuator operably coupled with the second disk opener and configured to alter a position of the second disk opener relative to the second frame. A computing system is operably coupled with the first row unit and the second row unit. The computing system is configured to activate the first actuator to alter a position of the first disk opener relative to the first frame and activate the second actuator to alter a position of the second disk opener relative to the second frame, wherein the activation of the first actuator is independent of the activation of the second actuator.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of a planting implement in accordance with aspects of the present subject matter;

FIG. 2 illustrates a perspective view of a row unit for a planting implement in accordance with aspects of the present subject matter;

FIG. 3 illustrates a partial, front view of a row unit for a planting implement in accordance with aspects of the present subject matter;

FIG. 4 illustrates a partial cross-sectional view of a row unit for a planting implement in accordance with aspects of the present subject matter taken along the line IV-IV of FIG. 3;

FIG. 5 illustrates a block diagram of components of a system for selectively adjusting one or more row units of a planting implement in accordance with aspects of the present subject matter;

FIG. 6 is a schematic block diagram illustrating portions of the system of FIG. 5 in accordance with aspects of the present subject matter; and

FIG. 7 illustrates a flow diagram of a method for an agricultural operation in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to a material within a fluid circuit. For example, “upstream” refers to the direction from which a material flows, and “downstream” refers to the direction to which the material moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to a system for a planting implement having one or more row units. Each row unit may be configured to form a furrow having a desired depth within the soil of a field. Thereafter, each row unit may deposit an agricultural product, such as seeds, fertilizers, pesticides, and other chemicals and materials, within the corresponding furrow and subsequently closes the corresponding furrow after the agricultural product has been deposited.

In some instances, each row unit may include a frame and a disk opener rotatably coupled to the frame. The disk opener may be configured to form a furrow within a field across which the planting implement is traveling. In addition, the row unit can include one or more gauge wheels that may be configured to set the penetration depth of the one or more disk openers. In this respect, the positioning of the one or more gauge wheels relative to the frame sets the depth to which the one or more disk openers penetrate the soil and, thus, the depth of the furrow being formed by the row unit.

Furthermore, the row unit may include a dispensing system supported on the frame. In some cases, the dispensing system may be configured to deposit the agricultural product into the furrow formed by the one or more disk openers such that the portions of the agricultural product are spaced apart from each other within the furrow by a predetermined distance. In several embodiments, the row unit may further include a closing assembly. In this respect, the closing assembly may be configured to close the furrow after the agricultural product has been deposited therein, such as by collapsing the excavated soil into the furrow.

The row unit may further include a furrow depth adjustment system capable of maintaining a defined furrow depth and/or a furrow depth within a defined furrow depth range. For instance, the furrow depth adjustment system may include a controller, an actuator, and/or a depth sensor. The controller may be configured to activate and deactivate the actuator. The actuator can be operably coupled with the disk opener and configured to alter a position of the disk opener relative to the frame to adjust a depth of the furrow. The depth sensor may be configured to capture data indicative of a detected furrow depth of the furrow.

A computing system may be communicatively coupled to the furrow depth adjustment system. The computing system may be configured to receive the data indicative of the detected furrow depth of the furrow and activate the actuator to alter the position of the disk opener relative to the frame based on a deviation of the detected furrow depth of the furrow from a defined furrow depth range. In some instances, the controller may additionally or alternatively receive the data indicative of the detected furrow depth of the furrow and activate the actuator to alter the position of the disk opener relative to the frame based on a deviation of the detected furrow depth of the furrow from a defined furrow depth range. By analyzing the sensor data, the furrow depth adjustment system may be capable of maintaining a defined furrow depth and/or a furrow depth within a defined furrow depth range.

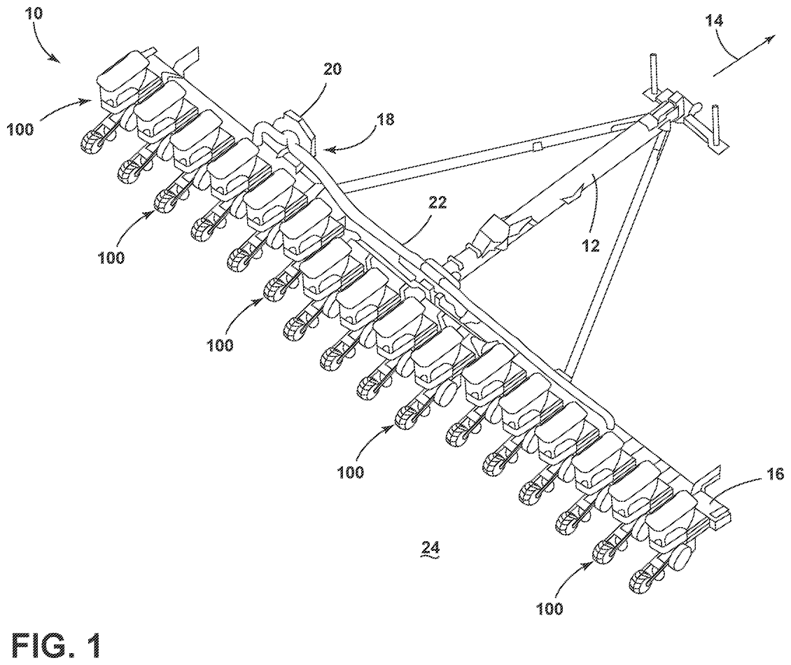

Referring now to the drawings, FIG. 1 illustrates a perspective view of a planting implement 10 in accordance with aspects of the present subject matter. In the illustrated embodiment, the planting implement 10 is configured as a planter. However, in alternative embodiments, the planting implement 10 may generally correspond to any suitable seed-planting equipment or implement, such as seeder or any other seed-dispensing implement.

As shown in FIG. 1, the planting implement 10 includes a tow bar 12. In general, the tow bar 12 may be configured to couple to a tractor or other agricultural vehicle, such as via a suitable hitch assembly. In this respect, the tractor may tow the planting implement 10 across a field in a direction of travel (indicated by arrow 14) to perform a planting operation on the field.

Furthermore, the planting implement 10 includes a toolbar 16 coupled to an aft end portion of the tow bar 12. For instance, the toolbar 16 may be configured to support and/or couple to one or more components of the planting implement 10. In some examples, the toolbar 16 may be configured to support a plurality of seed-planting units or row units 100. Each row unit 100 may be configured to form a furrow having a desired depth within the soil of a field. Thereafter, each row unit 100 may deposit an agricultural product, such as seeds and/or a fertilizer, within the corresponding furrow and subsequently closes the corresponding furrow after the agricultural product has been deposited. In general, the planting implement 10 may include any number of row units 100. For example, in the illustrated embodiment, the planting implement 10 includes sixteen row units 100 coupled to the toolbar 16. However, in other embodiments, the planting implement 10 may include six, eight, twelve, twenty-four, thirty-two, or thirty-six row units 100.

Additionally, in some embodiments, the planting implement 10 can include a pneumatic distribution system 18. In general, the pneumatic distribution system 18 is configured to distribute seeds from a bulk storage tank to the individual row units 100. As such, the pneumatic distribution system 18 may include a fan 20 or other pressurized air source and a plurality of seed conduits 22 extending between the fan 20 and the row units 100. In this respect, the pressurized air generated by the fan 20 conveys the seeds from the bulk storage tank through the seed conduits 22 to the individual row units 100. However, the seeds may be provided to the row units 100 in any other suitable manner.

It will be further appreciated that the configuration of the planting implement 10 described above and shown in FIG. 1 is provided only to place the present subject matter in an exemplary field of use. Thus, it will be appreciated that the present subject matter may be readily adaptable to any agricultural implement configuration.

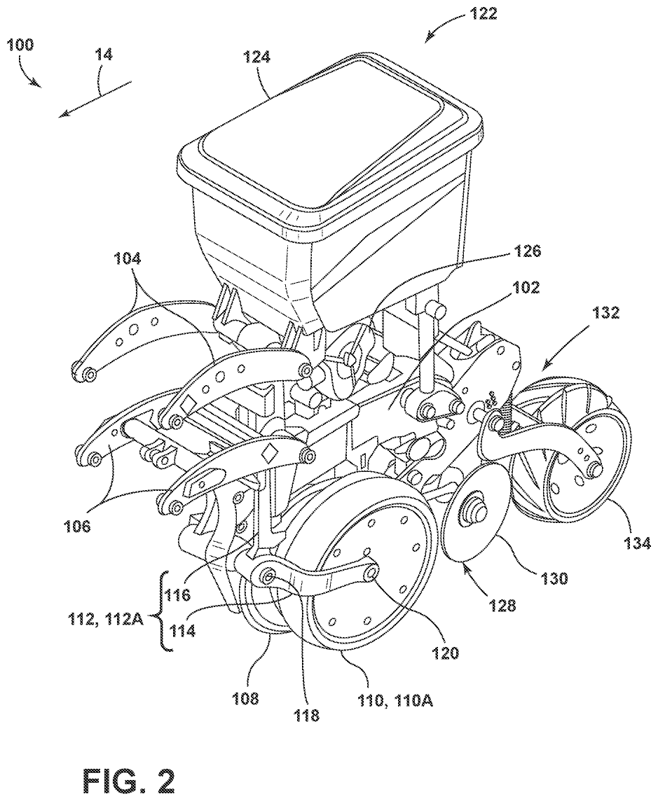

Referring now to FIG. 2, a perspective view of a row unit 100 for a planting implement is illustrated in accordance with aspects of the present subject matter. In general, the row unit 100 will be described herein with reference to the planting implement 10 described above with reference to FIG. 1. However, it will be appreciated by those of ordinary skill in the art that the disclosed row unit 100 may generally be utilized with planting implements having any other suitable implement configuration.

As shown, the row unit 100 may include a frame 102 adjustably coupled to the toolbar 16 by upper and lower links 104, 106. For example, one end portion of each link 104, 106 may be pivotably coupled to the frame 102 of the row unit 100. Conversely, an opposed end portion of each link 104, 106 may be pivotably coupled to the toolbar 16. As such, the links 104, 106 may allow for adjustment of the vertical position of the row unit 100 relative to the toolbar 16. However, in alternative embodiments, the row unit 100 may be coupled to the toolbar 16 in any other suitable manner.

Moreover, the row unit 100 includes one or more disk openers 108 rotatably coupled to the frame 102. In general, the one or more disk openers 108 may be configured to form a furrow within a field across which the planting implement 10 is traveling. For example, the one or more disk openers 108 can penetrate the soil of the field to a desired furrow depth and can rotate relative to the soil as the planting implement 10 moves across the field in the direction of travel 14, thereby forming a furrow.

In addition, the row unit 100 can include one or more gauge wheels 110 adjustably coupled to the frame 102 via one or more gauge wheel arms 112. In some cases, the one or more gauge wheels 110 may be configured to set the penetration depth of the one or more disk openers 108. In various examples, as the planting implement 10 moves across the field in the direction of travel 14, the one or more gauge wheels 110 rolls along the surface of the field. In this respect, the positioning of the one or more gauge wheels 110 relative to the frame 102 sets the depth to which the one or more disk openers 108 penetrate the soil and, thus, the depth of the furrow being formed by the row unit 100.

In several embodiments, the one or more gauge wheels 110 may be rotatably coupled to the one or more gauge wheel arms 112, with the one or more gauge wheel arms 112 being pivotably coupled to the frame 102. For example, in some examples, each gauge wheel arm 112 includes a lower arm portion 114 pivotably coupled to the frame 102 at one end portion thereof via a corresponding pivot joint 118. Furthermore, each gauge wheel 110 is rotatably coupled to the lower arm portion 114 of one of the gauge wheel arms 112 at an opposed end portion thereof via a corresponding pivot joint 120. In addition, each gauge wheel arm 112 includes an upper arm portion 116 extending generally upward from the lower arm portion 114. As will be described below, the upper arm portion(s) 116 may engage a furrow depth adjustment system 200 such that the relative positioning of the one or more gauge wheels 110 and the frame 102 can be adjusted.

Furthermore, the row unit 100 includes a dispensing system 122 supported on the frame 102. In some cases, the dispensing system 122 is configured to deposit agricultural product, such as seeds and/or a fertilizer, into the furrow formed by the one or more disk openers 108 such that the portions of the agricultural product are spaced apart from each other within the furrow by a predetermined distance. For example, in some examples, the dispensing system 122 includes a hopper 124 coupled to the frame 102 configured to store seeds. In some embodiments, the hopper 124 may receive seeds from the bulk storage tank via the pneumatic distribution system 18. In addition, the dispensing system 122 may include a seed meter 126 configured to meter or otherwise dispense seeds from the hopper 124 into a seed tube at a predetermined rate. The seeds then fall through the seed tube and into the furrow such that the seeds are spaced apart by the predetermined distance.

In several embodiments, the row unit 100 may include a closing assembly 128 supported on the frame 102 aft of the one or more disk openers 108 and the seed tube relative to the direction of travel 14. In some examples, the furrow closing assembly 128 may include one or more closing disks 130 positioned relative to each other such that soil flows between the disks 130 as the planting implement 10 travels across the field. In this respect, the closing disks 130 are configured to close the furrow after seeds have been deposited therein, such as by collapsing the excavated soil into the furrow.

Moreover, in some embodiments, the row unit 100 may include a press wheel assembly 132 supported on the frame 102 aft of the closing assembly 128 relative to the direction of travel 14. In several embodiments, the press wheel assembly 56 may include a press wheel 134 configured to roll over the closed furrow to firm the soil over the seed and promote favorable seed-to-soil contact.

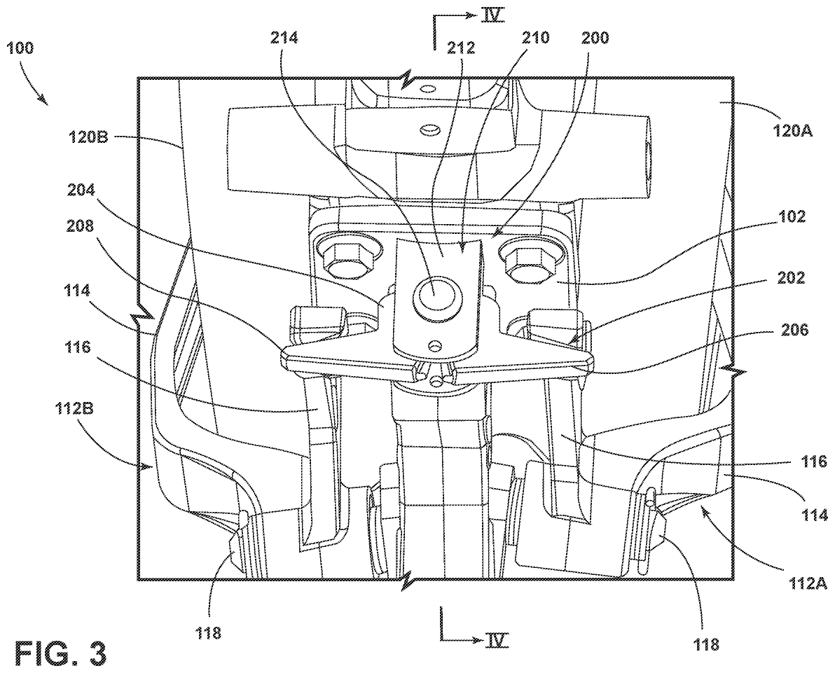

Referring now to FIG. 3, a partial, front view of the row unit 100 is illustrated according to various aspects of the present disclosure. As provided herein, the row unit 100 can include one or more gauge wheels 110 adjustably coupled to the frame 102 of the row unit 100 via one or more gauge wheel arms 112. For example, in the illustrated embodiment of FIG. 3, the row unit 100 includes a first gauge wheel 110A adjustably coupled to the frame 102 via a first gauge wheel arm 112A and a second gauge wheel 110B adjustably coupled to the frame 102 via a second gauge wheel arm 112B. However, in alternative embodiments, the row unit 100 may include any other suitable number of gauge wheels 110 and gauge wheel arms 112, such as a single gauge wheel 110 adjustably coupled to the frame 102 via a single gauge wheel arm 112.

Additionally, as mentioned above, the row unit 100 includes a furrow depth adjustment system 200. In general, the furrow depth adjustment system 200 can be configured to adjust the position of the one or more gauge wheels 110 relative to the frame 102, thereby adjusting the depth of the furrow being formed by the row unit 100. For instance, the furrow depth adjustment system 200 can be configured to pivot the one or more gauge wheel arms 112 relative to the frame 102 to make such adjustments.

In several embodiments, the furrow depth adjustment system 200 can include a wobble bracket 202. In some instances, the wobble bracket 202 can be configured to engage one or more gauge wheel arms 112. For example, the wobble bracket 202 may be in contact with the upper arm portion 116 of the one or more gauge wheel arms 112. As such, movement of the wobble bracket 202 causes the one or more gauge wheel arms 112 to pivot relative to the frame 102 about respective pivot joints 118.

The wobble bracket 202 may have any suitable configuration that allows the wobble bracket 202 to engage with the one or more gauge wheel arms 112 to allow for pivoting of the one or more gauge wheel arms 112. For example, in the illustrated embodiment, the wobble bracket 202 includes a base portion 204 and first and second arms 206, 208 extending outward from the base portion 204 in a direction generally perpendicular to the direction of travel 14. In this respect, the first arm 206 of the wobble bracket 202 is in contact with the upper arm portion 116 of the first gauge wheel arm 112A. Similarly, the second arm 208 of the wobble bracket 202 is in contact with the upper arm portion 116 of the second gauge wheel arm 112B. As such, linear movement of the wobble bracket 202 pivots the first and second gauge wheel arms 112A, 112B relative to the frame 102 about the corresponding pivot joints 118.

Moreover, the furrow depth adjustment system 200 can include a linkage arm 210 coupled to the wobble bracket 202. For example, the linkage arm 210 can be configured to linearly move the wobble bracket 202 relative to the frame 102 to pivot the one or more gauge wheel arms 112. In some cases, the linkage arm 210 can include a clevis portion 212 configured to receive the base portion 204 of the wobble bracket 202. Furthermore, in such an embodiment, the clevis portion 212 can be pivotably coupled to the base portion 204 of the wobble bracket 202 via a pin 214. The pin 214, in turn, allows the wobble bracket 202 to pivot within the clevis portion 212. However, in alternative embodiments, the linkage arm 210 may be coupled to the wobble bracket 202 in any other suitable manner.

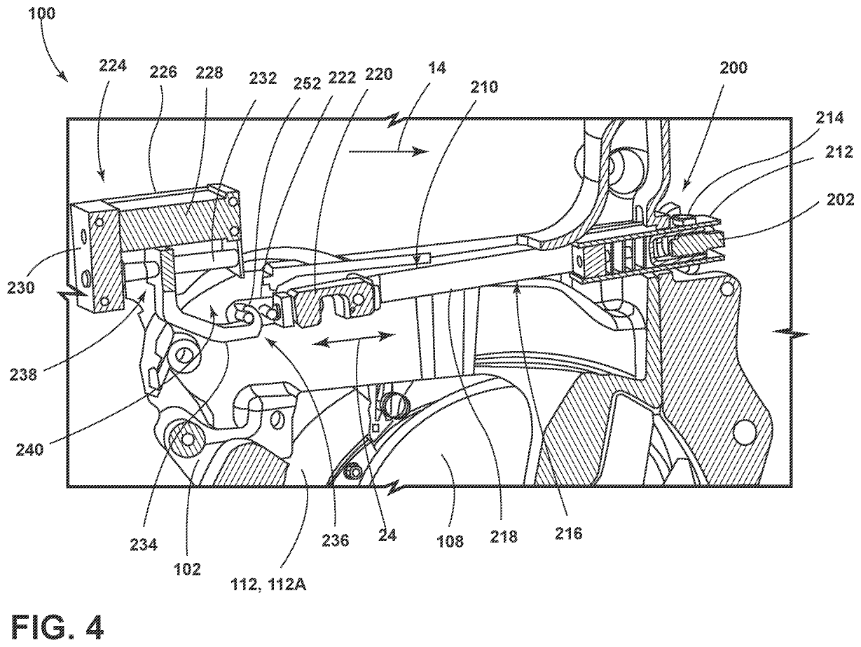

Referring now to FIG. 4, a partial cross-sectional view of the row unit 100 taken along the line IV-IV of FIG. 3 is provided. As shown, the wobble bracket 202 is generally positioned at the forward end of the row unit relative to the direction of travel 14. In this respect, the linkage arm 210 generally extends along the length of the row unit 100 (i.e., parallel to the direction of travel 14). As such, the clevis portion 212 of linkage arm 210 is similarly positioned at the forward end portion of the row unit 100 relative to the direction of travel 14.

The linkage arm 210 may have any suitable construction that allows motion to be transmitted along the length of the row unit 100 to the wobble bracket 202. For example, in the illustrated embodiment, the linkage arm 210 includes a center portion 216 coupled to and positioned aft portion of the clevis portion 212. The center portion 216 of the linkage arm 210 may be formed from a pair of parallel, spaced-apart side wall members 218 (one of which is shown). Additionally, in the illustrated embodiment, the linkage arm 210 can include a coupling block 220 coupled to (e.g., threadingly) and positioned aft of the center portion 216. Moreover, in the illustrated embodiment, the linkage arm 210 includes a rear portion 222 coupled to (e.g., threadingly) and positioned aft of the coupling block 220.

In addition, the furrow depth adjustment system 200 can include an actuator assembly 224 supported on the frame 102 of the row unit 100. In various examples, the actuator assembly 224 can be configured to linearly move the linkage arm 210 and the wobble bracket 202 to pivot the one or more gauge wheel arms 112 relative to the frame 102. In several embodiments, the actuator assembly 224 can include a housing 226 coupled to the frame 102. The housing 226 may, in turn, be configured to enclose and/or otherwise support one or more components of the actuator assembly 224. For instance, as shown in FIG. 4, the actuator assembly 224 can include an actuator 228 positioned within the housing 226. In various examples, the actuator 228 may be configured to generate the motion necessary to move the linkage arm 210. In various instances, the actuator 228 may be configured as a motor, a cylinder, and/or any other device that may be powered electrically, hydraulicly, pneumatically, magnetically, thermally, and/or through any other manner.

Additionally or alternatively, the actuator assembly 224 can include a gearbox 230 or transmission coupled to the actuator 228. In some instances, the actuator assembly 224 can further include a threaded shaft 232 that can be coupled to the gearbox 230. In this respect, the gearbox 230 can convert rotation generated by the actuator 228 into rotation of the threaded shaft 232 (e.g., at a different speed and/or with a different torque amount). Such rotation of the threaded shaft, in turn, causes the linkage arm 210 to linearly move (e.g., as indicated by arrow 242) in a manner that pivots the one or more gauge wheel arms 112.

In some examples, the actuator assembly 224 can be positioned adjacent to the aft end of the row unit 100 relative to the direction of travel 14. For example, as shown, the actuator assembly 224 may be positioned adjacent to a depth-setting register 240 defined by the frame 102 of the row unit 100. The depth-setting register 240 may be formed within the frame 102 to allow for manual furrow depth adjustments.

Furthermore, the furrow depth adjustment system 200 can include an actuation arm 234 having a first end portion 236 and an opposed, second end portion 238. In various instances, the actuation arm 234 is coupled to the linkage arm 210 at its first end portion 236 and to the threaded shaft 232 at its second end portion 238. As such, the actuation arm 234 may generally define an arcuate shape to permit such coupling. In this respect, the actuation arm 234 is configured to convert or otherwise transmit rotation of the threaded shaft 232 into linear movement of the linkage arm 210.

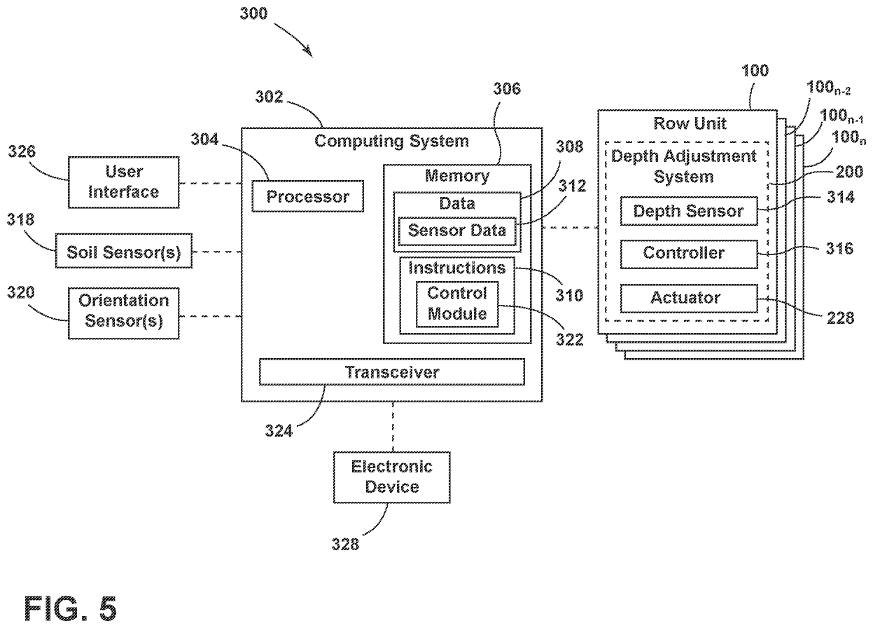

Referring to FIG. 5, a block view of a system 300 for operating various agricultural implements is illustrated in accordance with aspects of the present subject matter. In general, the system 300 will be described herein with reference to the planting implement 10 and the row unit 100 described above with reference to FIGS. 1-4. However, it will be appreciated that the disclosed system 300 may generally be utilized with any planter or seeder having any suitable implement configuration, with row units having any suitable row unit configuration, with seed meters having any suitable meter configuration and/or with seed transport members have any suitable transport member configuration. For purposes of illustration, communicative links, or electrical couplings of the system 300 shown in FIG. 5 are indicated by dashed lines. The one or more communicative links or interfaces may be one or more of various wired or wireless communication mechanisms, including any combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, providing data communication services.

In several examples, the system 300 may include a computing system 302 and various other components configured to be communicatively coupled to and/or controlled by the computing system 302, such as one or more row units 100 and a respective furrow depth adjustment system 200 for each row unit 100. Accordingly, while one row unit 100 and furrow depth adjustment system 200 is illustrated in FIG. 5, it will be appreciated that the planting implement 10 may include any number of row units 100, 100ₙ₋₂, 100ₙ₋₁, 100ₙ without departing from the scope of the present disclosure. As will be described below, the computing system 302 may be communicatively coupled to a respective actuator 228 of one or more row units 100. The computing system 302 is configured to receive data indicative of the detected furrow depth of the furrow and activate the actuator 228 (possibly through a respective controller 316 associated with each furrow depth adjustment system 200) to alter the position of the disk opener 108 relative to the frame 102 based on a deviation of the detected furrow depth of the furrow from a defined furrow depth range. By analyzing the sensor data, the furrow depth adjustment system 200 may be capable of maintaining a defined furrow depth and/or a furrow depth within a defined furrow depth range.

In general, the computing system 302 may comprise any suitable processor-based device, such as a computing device or any suitable combination of computing devices. Thus, in several embodiments, the computing system 302 may include one or more processors 304 and associated memory 306 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 306 of the computing system 302 may generally comprise memory elements including, but not limited to, a computer-readable medium (e.g., random access memory (RAM)), a computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 306 may generally be configured to store information accessible to the processor 304, including data 308 that can be retrieved, manipulated, created, and/or stored by the processor 304 and instructions 310 that can be executed by the processor 304 and configure the computing system 302 to perform various computer-implemented functions, such as one or more algorithms and/or related methods. In addition, the computing system 302 may also include various other suitable components, such as a communications circuit or module, one or more input/output channels, a data/control bus, and/or the like.

In several embodiments, the data 308 may be stored in one or more databases. For example, the memory 306 may include a sensor database 312 for storing sensor data from one or more sensors. For example, the data 308 may be associated with the operation of the furrow depth adjustment system 200, which may be received from a depth sensor 314. It will be appreciated that depth sensor 314 may generally correspond to any suitable sensing device configured to function as described herein. For example, in various instances, the depth sensor 314 may be configured as any device capable of determining a wheel position relative to the soil 24 (FIG. 1), a line scanner, a ground penetrating sensor (e.g., ground penetration radar unit), and/or any other practicable device.

The sensor data 308 may additionally or alternatively be associated with a soil sensor 318 associated with the row units 100. In various instances, the soil sensor 318 may be configured to generate data indicative of the soil composition within the field as the planting implement 10 moves across the field. It will be appreciated that the soil sensor 318 may generally correspond to any suitable sensing device configured to function as described herein. For example, in various embodiments, the soil sensor 318 may include an emitter configured to emit an electromagnetic radiation signal, such as an ultraviolet radiation signal, a near-infrared radiation signal, a mid-infrared radiation signal, or a visible light signal for reflection off of the soil 24 (FIG. 1). The soil sensor 318 may also include a receiver configured to receive the reflected electromagnetic radiation signal. One or more spectral parameters (e.g., the amplitude, frequency, and/or the like) of the reflected electromagnetic radiation signal may, in turn, be indicative of the soil composition. In this regard, the emitter may be configured as a light-emitting diode (LEDs), or another electromagnetic radiation-emitting device and the receiver may be configured as a photoresistor or other electromagnetic radiation-receiving device. However, in alternative embodiments, the soil sensor 318 may have any other suitable configuration and/or components.

The sensor data 308 may additionally or alternatively be associated with an orientation sensor 320 associated with the row units 100. In various instances, the orientation sensor 320 may be configured to capture data related to a position, angle, displacement, distance, speed, acceleration of each row unit 100 relative to other row units 100 and/or the planting implement 10 relative to a flat position. It will be appreciated that the soil sensor 318 may generally correspond to any suitable sensing device configured to function as described herein. For example, in various embodiments, the orientation sensor 320 may be configured as an imaging sensor, a LIDAR, a RADAR sensor, a Hall effect sensor, a gyroscope sensor, a magnetometer sensor, an accelerometer sensor, a yaw-rate sensor, a piezoelectric sensor, a position sensor, a complementary metal-oxide-semiconductor (CMOS) sensor, a pressure sensor, a capacitive sensor, an ultrasonic sensor, or any other suitable type of sensor.

During operation of the system 300, data from all or a portion of the sensors communicatively coupled to the computing system 302 may be stored (e.g., temporarily) within the sensor database 312 and subsequently used to determine one or more operating parameters associated with the operation of the furrow depth adjustment system 200 and/or the planting implement 10.

Additionally, in several embodiments, the instructions 310 stored within the memory 306 of the computing system 302 may be executed by the processor(s) 304 to implement a control module 322. In general, the control module 322 may be configured to sample and/or evaluate the data received from the various sensors communicatively coupled to the computing system 302 and/or other inputs received by the computing system 302. In various examples, the control module 322 may be configured to sample and/or evaluate the data from one or more of the sensors described herein continuously, periodically, or only as demanded. Based on the data, the control module 322 may provide instructions 310 to alter or manipulate the furrow depth adjustment system 200. Additional data may be provided to the computing system 302 (or the controller 316 of the furrow depth adjustment system 200) after the alteration or manipulation of the furrow depth adjustment system 200, which can lead to subsequent alterations or manipulations to maintain a detected furrow depth within a defined furrow depth range.

Moreover, as shown in FIG. 5, the computing system 302 may also include a transceiver 324 to communicate via wired and/or wireless communication with any of the various other system components described herein. For instance, one or more communicative links or interfaces (e.g., one or more data buses) may be provided between the transceiver 324 and each row unit 100 to allow the computing system 302 to transmit control signals for controlling the operation of such components. Similarly, one or more communicative links or interfaces (e.g., one or more data buses) may be provided between the transceiver 324 and the various sensors to allow the associated sensor data to be transmitted to the computing system 302.

Furthermore, in some embodiments, the system 300 may also include a user interface 326 in communication with the computing system 302. In some cases, the user interface 326 may be configured to provide feedback (e.g., notifications associated with the operational parameters of each row unit 100) to the operator of the planting implement 10. As such, the user interface 326 may include one or more feedback devices, such as display screens, speakers, warning lights, and/or the like, which are configured to communicate such feedback. In addition, some embodiments of the user interface 326 may include one or more input devices, such as touchscreens, keypads, touchpads, knobs, buttons, sliders, switches, mice, microphones, and/or the like, which are configured to receive user inputs from the operator, which may be a defined furrow depth range and/or a defined furrow depth. In various examples, the user interface 326 may be positioned within a cab of a work vehicle configured to tow the planting implement 10 across the field. However, in alternative embodiments, the user interface 326 may have any suitable configuration and/or be positioned in any other suitable location.

Further, the computing system 302 may also communicate via wired and/or wireless communication with one or more remote electronic devices 328 through the transceiver 324. The electronic device 328 may include a display for displaying information to a user. For instance, the electronic device 328 may display one or more user interfaces and may be capable of receiving remote user inputs to set a predefined threshold for any of the operating parameters and/or to input any other information, such as the agricultural product to be used. In addition, the electronic device 328 may provide feedback information, such as visual, audible, and tactile alerts, and/or allow the user to provide one or more inputs through the usage of the remote electronic device 328, which may be a defined furrow depth range and/or a defined furrow depth. It will be appreciated that the electronic device 328 may be any one of a variety of computing devices and may include a processor and memory. For example, the electronic device 328 may be a cell phone, mobile communication device, key fob, wearable device (e.g., fitness band, watch, glasses, jewelry, wallet), apparel (e.g., a tee shirt, gloves, shoes, or other accessories), personal digital assistant, headphones and/or other devices that include capabilities for wireless communications and/or any wired communications protocols.

Additionally or alternatively, a defined furrow depth range and/or a defined furrow depth may be found or selected in any other suitable way, such as from a predetermined look-up table stored in the computing system 302 and/or one or more controllers 316. In some instances, the look-up tables may be based on the agricultural product being deposited within the field and/or an application map that is stored within the computing system 302.

It will be appreciated that, in general, the computing system 302 of the disclosed system 300 may correspond to any suitable computing device(s) that is configured to function as described herein. In several embodiments, the computing system 302 may form part of an active planting system configured to perform a planting operation, such as by corresponding to a vehicle controller of a work vehicle configured to tow an associated planting implement 10 and/or an associated implement controller of the planting implement 10. Alternatively, the computing system 302 may comprise a separate computing device(s) configured to be used primarily for the purpose of performing the various calibration methods and/or routines described herein.

It should additionally be appreciated that the computing system 302 may correspond to an existing controller of the planting implement 10 or an associated work vehicle or the computing system 302 may correspond to a separate processing device. For instance, in some cases, the computing system 302 may form all or part of a separate plug-in module that may be installed within the planting implement 10 or associated work vehicle to allow for the disclosed system and method to be implemented without requiring additional software to be uploaded onto existing control devices of the planting implement 10 or the associated work vehicle.

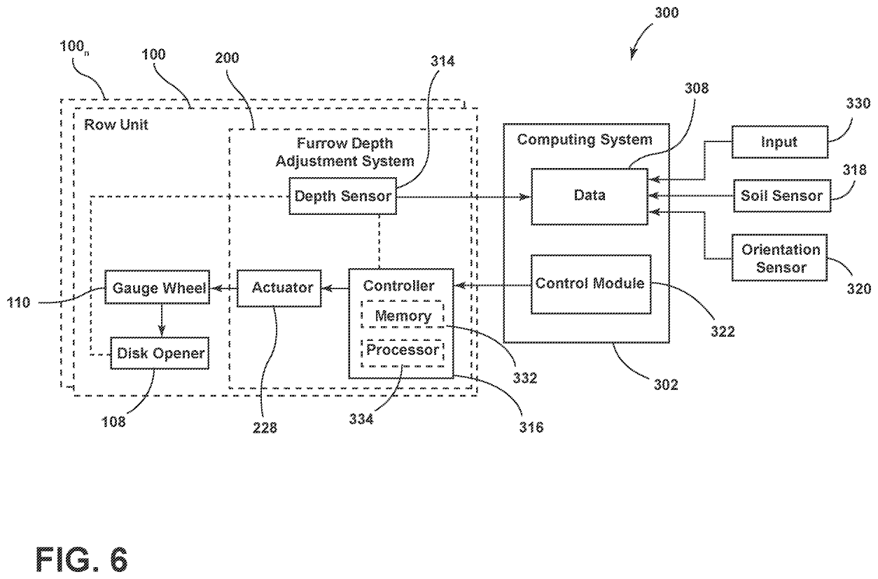

Referring now to FIG. 6, various components of the system 300 are illustrated in accordance with various aspects of the present disclosure. As shown, the computing system 302 may receive data from various components of the system 300 and, in turn, alter or manipulate the furrow depth adjustment system 200. Additional data may be provided after the alteration or manipulation of the furrow depth adjustment system 200, which can lead to subsequent alterations or manipulations to maintain a detected furrow depth within the defined furrow depth range for each row unit 100.

As illustrated, the computing system 302 may receive an input 330 related to a desired furrow depth. As provided herein, in some instances, one or more gauge wheels 110 may be configured to set the penetration depth of one or more disk openers 108 that can penetrate into the soil 24 (FIG. 1) of the field as the planting implement 10 moves across the field in the direction of travel 14, thereby forming a furrow.

In various instances, the input 330 may be received from a component of the tractor or the planting implement 10, such as a user interface 326. Additionally or alternatively, the input 330 may be received from a device that is remote from the tractor or the planting implement 10. Additionally or alternatively, the input 330 may be provided in any other suitable way, such as from a predetermined look-up table stored in the computing system 302 and/or one or more controllers 316. In some instances, the input 330 may vary the furrow depth of a first row unit 100 from a second row unit 100ₙ for various purposes, such as the planting implement 10 traversing a turning condition, the product being deposited based on a variable prescription map, various products being deposited within the soil 24 (FIG. 1), the planting implement 10 traversing uneven ground, variations in the soil 24 (FIG. 1), and/or for any other purpose.

Based on the input 330, the control module 322 may determine a depth alteration for each row unit 100 to maintain each furrow within the defined furrow depth range. In turn, the control module 322 may provide instructions 310 to a controller 316 of each row unit 100. In some cases, the controller 316 may be operably coupled with the actuator 228 and the computing system 302. As such, the computing system 302 can activate the actuator 228 by providing instructions 310 to the controller 316 and, in turn, the controller 316 manipulates the actuator 228 based on the instructions 310 provided by the computing system 302. Additionally or alternatively, the computing system 302 may provide instructions 310 to the actuator 228.

In various examples, the instructions 310 may be based on a variation of the furrow depth from the defined furrow depth range and other considerations, such as a soil composition along the planting implement 10, which may be provided by the soil sensor 318, and/or a planting implement orientation, which may be provided by the orientation sensor 320. Based on the instructions 310, the actuator 228 of each row unit 100 may be activated, if a change in depth of one or more row units 100 is needed to maintain the defined depth range.

In addition, as the planting implement 10 is in use, a depth sensor 314 associated with each respective row unit 100 may capture data related to a depth of the furrow and/or the depth of the disk opener 108. The data provided by the depth sensor 314 may be provided to the computing system 302, which may provide additional instructions 310 to the row unit 100 should a subsequent manipulation or alteration be needed to accomplish the defined furrow depth range.

In some instances, the data provided from the depth sensor 314 may additionally or alternatively be provided to the controller 316 of each row unit 100 such that subsequent modifications of the actuator 228 may be performed without additional instructions 310 from the computing system 302 that may be remote from the row unit 100. It will be appreciated that the controller 316 may be any one of a variety of computing devices and may include a processor 332 and memory 334.

With further reference to FIG. 6, while one row unit 100 is schematically illustrated, each row unit 100 may include a respective furrow depth adjustment system 200. As such, the computing system 302 may be operably coupled with a first row unit 100 and a second row unit 100ₙ that are laterally offset from one another. In some instances, the computing system 302 may be configured to activate the first actuator 228 to alter a position of the first disk opener 108 relative to the first frame 102 and activate the second actuator 228 to alter a position of the second disk opener 108 relative to the second frame 102. The activation of the first actuator 228 may be independent of the activation of the second actuator 228. In addition, in some instances, a first depth sensor 314 may be positioned within the first row unit 100, and a second depth sensor 314 may be positioned within the second row unit 100n. The computing system 302 may be configured to receive data indicative of the detected depth of the first furrow from the first depth sensor 314 and data indicative of the detected depth of the second furrow from the second depth sensor 314. In turn, a vertical position of the first row unit 100 relative to the toolbar 16 is varied from a vertical position of the second row unit 100ₙ relative to the toolbar 16.

As such, the system 300 may allow for closed-loop control of one or more row units 100 by the control module 322 to allow for the inputted defined furrow depth range to be accomplished for each row unit 100. Additionally or alternatively, the system 300 may allow for closed-loop control of each row unit 100 by the controller 316 of each row unit 100 for the inputted defined furrow depth range to be accomplished for each row unit 100.

In various examples, the system 300 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the computing system 302 302 and/or each controller 316 and may be used to generate a predictive evaluation of the alterations to the actuator 228. For instance, the control module 322 may alter the actuator 228. In turn, the depth sensor 314 may monitor the corresponding furrow depth changes. Each change may be fed back into the control module 322 and/or the controller 316 for each row unit 100 for further alterations to the actuator 228.

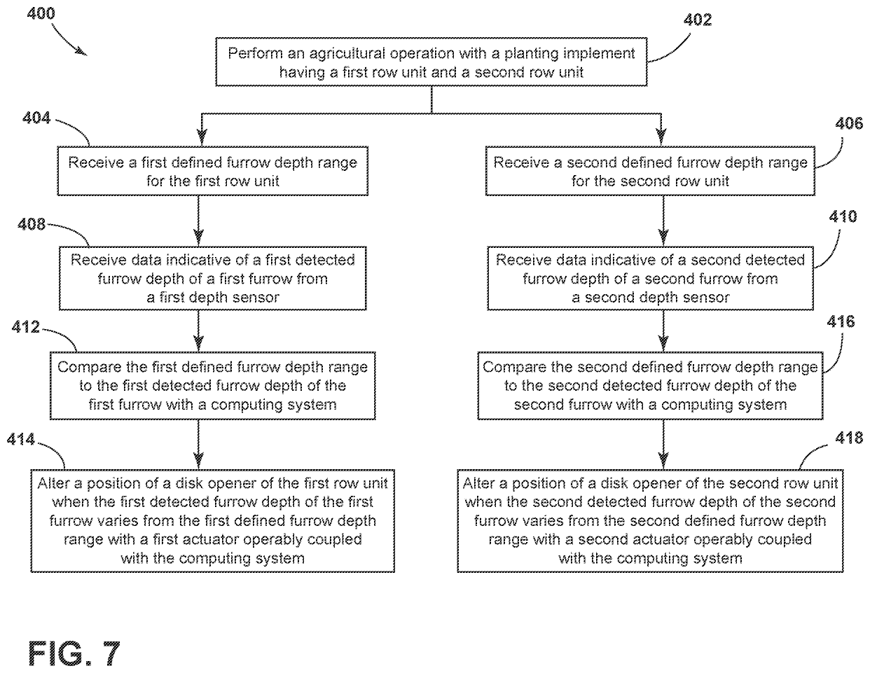

Referring now to FIG. 7, a flow diagram of some examples of a method 400 for an agricultural operation is illustrated in accordance with aspects of the present subject matter. In general, the method 400 will be described herein with reference to the planting implement 10 and one or more row units 100 described above with reference to FIGS. 1-6. However, the disclosed method 400 may generally be utilized with any suitable vehicle and/or implement. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As illustrated in FIG. 7, at (402), the method 400 can include performing an agricultural operation with a planting implement having a first row unit and a second row unit. Each row unit may be configured to form a furrow having a desired depth within the soil of a field. Thereafter, each row unit may deposit an agricultural product, such as seeds and/or a fertilizer, within the corresponding furrow and subsequently closes the corresponding furrow after the agricultural product has been deposited. In general, the planting implement may include any number of row units. As such, while the described method includes a first row unit and a second row unit, the planting implement may include any number of row units without departing from the teachings provided herein.

At (404), the method 400 can include receiving a first defined furrow depth range for a first row unit. Similarly, at (406), the method 400 can include receiving a second defined furrow depth range for a second row unit. In various examples, the first defined furrow depth range and the second defined furrow depth range may be equal or varied from one another. In instances in which the first defined furrow depth range and the second defined furrow depth range are common with one another, a single input may be used to input each of the first defined furrow depth range and the second defined furrow depth range.

In addition, in some examples, the first defined furrow depth range and/or the second defined furrow depth range may be received from a user interface operably coupled with the computing system. Additionally or alternatively, in various examples, the first defined furrow depth range and/or the second defined furrow depth range may be received from an electronic device operably coupled with the computing system. Additionally or alternatively, in several examples, the first defined furrow depth range and the second defined furrow depth range are determined based on one or more look-up tables.

At (408), the method 400 can include receiving data indicative of a first detected furrow depth of a first furrow from a first depth sensor. Likewise, at (410), the method 400 can include receiving data indicative of a second detected furrow depth of a second furrow from a second depth sensor. As provided herein, the first depth sensor may be configured to capture data indicative of a detected furrow depth of the first furrow and the second depth sensor may be configured to capture data indicative of a detected furrow depth of the second furrow.

At (412), the method 400 can include comparing the first defined furrow depth range to the first detected furrow depth of the first furrow with a computing system. At (414), the method 400 can include altering a position of a disk opener of the first row unit when the first detected furrow depth of the first furrow varies from the first defined furrow depth range with a first actuator operably coupled with the computing system. In some cases, altering the position of the disk opener of the first row unit when the first detected furrow depth of the first furrow varies from the first defined furrow depth range can further include providing instructions from the computing system to a controller associated with the first row unit. In turn, the first controller can be configured to manipulate the first actuator.

At (416), the method 400 can include comparing the second defined furrow depth range to the second detected furrow depth of the second furrow with the computing system. At (418), the method 400 can include altering a position of a disk opener of the second row unit when the second detected furrow depth of the second furrow varies from the second defined furrow depth range with a second actuator operably coupled with the computing system. In some cases, altering the position of the disk opener of the second row unit when the second detected furrow depth of the second furrow varies from the second defined furrow depth range can further include providing instructions from the computing system to a controller associated with the second row unit. In turn, the second controller can be configured to manipulate the second actuator.

In various examples, the method 400 may implement machine learning methods and algorithms that utilize one or several vehicle learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update an amount of movement of the actuators. In some instances, the vehicle learning engine may allow for changes to the actuators to be performed without human intervention.

It is to be understood that the steps of any method disclosed herein may be performed by a computing system upon loading and executing software code or instructions which are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions which are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for a planting implement having one or more row units, the system comprising:
a frame;
a disk opener rotatably coupled to the frame, the disk opener configured to form a furrow within a field across which the planting implement is traveling;
an actuator operably coupled with the disk opener and configured to alter a position of the disk opener relative to the frame;
a depth sensor configured to capture data indicative of a detected furrow depth of the furrow; and
a computing system communicatively coupled to the actuator, the computing system being configured to:
receive the data indicative of the detected furrow depth of the furrow; and
activate the actuator to alter the position of the disk opener relative to the frame based on a deviation of the detected furrow depth of the furrow from a defined furrow depth range.

2. The system of claim 1, further comprising:
a gauge wheel arm pivotably coupled to the frame; and
a gauge wheel rotatably coupled to the gauge wheel arm, wherein the gauge wheel is configured to roll along a surface of the field and support the disk opener.

3. The system of claim 1, further comprising:
a user interface operably coupled with the computing system, wherein the defined furrow depth range is received through the user interface.

4. The system of claim 1, further comprising:
a controller operably coupled with the actuator and the computing system, wherein the computing system activates the actuator by providing instructions to the controller and the controller manipulates the actuator based on the instructions provided by the computing system.

5. The system of claim 4, wherein the depth sensor is further coupled with the controller.

6. The system of claim 5, wherein one or more subsequent modifications of the actuator is performed based on the data from the depth sensor that is provided to the controller.

7. The system of claim 6, wherein the one or more subsequent modifications are performed without additional instructions from the computing system.

8. The system of claim 2, further comprising:
a wobble bracket configured to engage the gauge wheel arm; and
a linkage arm coupled to the wobble bracket,
wherein the actuator is configured to move the linkage arm relative to the frame in a manner that adjusts a position of the gauge wheel relative to the frame.

9. The system of claim 1, wherein the depth sensor is configured as a ground-penetrating sensor.

10. A method for an agricultural operation, the method comprising:
receiving a first defined furrow depth range for a first row unit;
receiving, from a first depth sensor, data indicative of a first detected furrow depth of a first furrow;
comparing, with a computing system, the first defined furrow depth range to the first detected furrow depth of the first furrow; and
altering, with a first actuator operably coupled with the computing system, a position of a first disk opener of the first row unit when the first detected furrow depth of the first furrow varies from the first defined furrow depth range.

11. The method of claim 10, further comprising:
receiving a second defined furrow depth range for a second row unit;
receiving, from a second depth sensor, data indicative of a second detected furrow depth of a second furrow;
comparing, with the computing system, the second defined furrow depth range to the second detected furrow depth of the second furrow; and
altering, with a second actuator operably coupled with the computing system, a position of a second disk opener of the second row unit when the second detected furrow depth of the second furrow varies from the second defined furrow depth range.

12. The method of claim 11, wherein the first defined furrow depth range and the second defined furrow depth range are received from a user interface operably coupled with the computing system.

13. The method of claim 11, wherein the first defined furrow depth range and the second defined furrow depth range are received from an electronic device operably coupled with the computing system.

14. The method of claim 11, wherein the first defined furrow depth range and the second defined furrow depth range are determined based on one or more look-up tables.

15. The method of claim 10, wherein altering the position of the disk opener of the first row unit when the first detected furrow depth of the first furrow varies from the first defined furrow depth range further comprises providing instructions from the computing system to a first controller associated with the first row unit, and wherein the first controller is configured to manipulate the first actuator.

16. A system for a planting implement, the system comprising:
a toolbar;
a first row unit coupled to the toolbar, the first row unit comprising:
a first frame;
a first disk opener rotatably coupled to the first frame, the first disk opener configured to form a first furrow within a field across which the planting implement is traveling;
a first depth sensor configured to capture data indicative of a detected furrow depth of the first furrow; and
a first actuator operably coupled with the first disk opener and configured to alter a position of the first disk opener relative to the first frame;
a second row unit coupled to the toolbar, the second row unit comprising:
a second frame;
a second disk opener rotatably coupled to the second frame, the second disk opener configured to form a second furrow within a field across which the planting implement is traveling;
a second depth sensor configured to capture data indicative of a detected furrow depth of the second furrow; and
a second actuator operably coupled with the second disk opener and configured to alter a position of the second disk opener relative to the second frame; and
a computing system operably coupled with the first row unit and the second row unit, the computing system being configured to:
activate the first actuator to alter a position of the first disk opener relative to the first frame; and
activate the second actuator to alter a position of the second disk opener relative to the second frame, wherein the activation of the first actuator is independent of the activation of the second actuator.

17. The system of claim 16, wherein the computing system is further configured to:
receive the data indicative of the detected depth of the first furrow from the first depth sensor; and
receive the data indicative of the detected depth of the second furrow from the second depth sensor.

18. The system of claim 17, wherein the first depth sensor is positioned within the first row unit and the second depth sensor is positioned within the second row unit.

19. The system of claim 16, wherein a vertical position of the first row unit relative to the toolbar is varied from a vertical position of the second row unit relative to the toolbar.

20. The system of claim 16, further comprising:
a soil sensor operably coupled with the computing system, wherein altering a position of the first disk opener relative to the first frame or altering a position of the first disk opener relative to the first frame is at least based in part on data provided by the soil sensor.
